(19) United States
(12) Patent Application Publication
(10) Pub. No.: US 2008/0154991 A1
(43) Pub. Date: Jun. 26, 2008

(54) Non-volatile storage system monitoring of a file system

(76) Inventors: Kirk Davis, Gilbert, AZ (US); Dipak Patel, Gilbert, AZ (US); Pramod R. Pesara, Chandler, AZ (US); Daniel Post, Sacramento, CA (US); Kris R. Murray, Folsom, CA (US); Richard J. Durante, El Dorado Hills, CA (US); Steve Wells, El Dorado Hills, CA (US); Jack Chen, Ta-Li City Taichung (TW); Meenakshi Pannala, El Dorado Hills, CA (US)

Correspondence Address: LEE & HAYES, PLLC;c/o Intellevate, LLC, P.O. BOX 52050, MINNEAPOLIS, MN, 55402, US

(21) Appl. No.: 11/643,087

(22) Filed: Dec. 21, 2006

(51) Int. Cl. G06F 17/30

(52) U.S. Cl. 707/205

(57) ABSTRACT

Embodiments and implementations of non-volatile storage system monitoring of a file system are described herein.

### BACKGROUND

Electronic memory comes in a variety of forms to serve a variety of purposes. Two types of memory currently in use are volatile and non volatile memory. Volatile memory requires constant power to retain data. When the system is shut down any stored data is lost. Non volatile memory does not require constant power to retain data and, thus can retain data even if the system is shut down. Nonvolatile memory such as “not or” (NOR) and “not and” (NAND) read only memory (ROM) may be used for cell phone data storage, digital camera data storage, solid state drives for computing devices, (e.g., personal computers) as well as other electronic devices. Nonvolatile memory has several advantages including that it is relatively lightweight, has no moving parts, is relatively small in size, is quiet and allows for fast access to data by a host.

Volatile memory has the ability to have data written upon it without having to first perform an erase function to remove existing unwanted data. With Nonvolatile memory, however, existing data is generally erased before new data is written. Moreover, traditional techniques involved erasing previous data immediately before the new data was written. The process of erasing the previous data, however, may take as long or longer than writing the new data.

### BRIEF DESCRIPTION OF THE DRAWINGS

FIG. 1 is an illustration of an exemplary implementation of an environment in which a nonvolatile memory device is connected to a host.

FIG. 2 shows software components of a memory storage device operable to scan the file system and pre-erase invalid sectors in the flash memory.

FIG. 3 shows a flowchart of the process of scanning the file system and erasing invalid sectors in the memory device.

### DETAILED DESCRIPTION

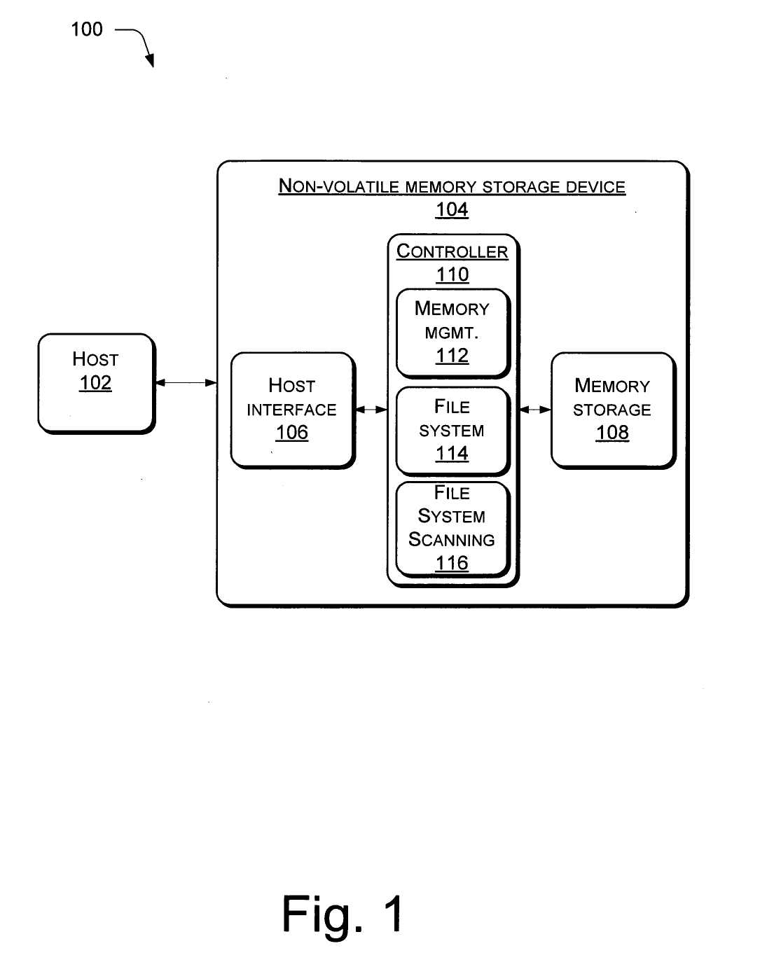

FIG. 1 shows a system 100 including a host 102, such as a computing device, connected to a nonvolatile memory device 104 in a conventional manner, such as through a USB or PCI express connection connected to the system bus (not shown) of host 102. The computing device may be a computer, mobile phone, digital camera, smart appliance, or other electronic device operable to connect to a nonvolatile memory storage device 104. The computing device may include or be connected to a display device, such as a liquid crystal display (LCD). The non-volatile memory storage device 104 may take the form of a universal serial bus (USB) memory key or stick, hard drive cache, basic input-output system (BIOS) chip, CompactFlash device, SmartMedia device, Personal Computer Memory Card International Association (PCMCIA) Type I or Type II memory card, memory cards for video game consoles or other read only memory (ROM) device. The storage device 104 may have a host interface 106, memory storage 108 and a controller 110 for receiving signals from host interface 106 and generating flash memory accesses in response.

Host interface 106 may comprise a module for receiving signals from host 102 and sending the message or memory access request to the controller 110. The nonvolatile memory storage 108 may include flash memory, such as a NAND or NOR flash memory chip, or other memory medium that permits a page, or block, containing sectors of memory to be erased before being written upon with new data. Memory storage 108 may be arranged as an array or matrix of electrically erasable transistor cells. Each transistor cell may include a source region, drain region, floating gate, and control gate. The gates may be separated by a thin insulation layer such as an oxide or nitride. The control gate may be connected to a word line, the source region may be connected to a source line or ground, the drain may be connected to a bit line, and the floating gate may be connected to the word line through the control gate and to the bit line through the drain. If the transistor cells are arranged matrix arrangement, the bit lines may be arranged as columns, while the word lines may be arranged as rows.

Data may be stored in the memory by altering electrons in the floating gate. A charge may be applied from the bit line to the floating gate and drain through the source or ground. Applying a charge creates a negatively charged barrier in the thin insulation layer between the floating gate and control gate by trapping excited electrons on the opposite side of the thin insulation layer from the floating gate. When the flow of electrons through the gate is greater than one-half of the trapped charge, the gate is “open” and the cell has value of 1. When flow is less than one-half of the trapped charge, the cell has a value of zero. Thus, the cell can be erased, or returned to the normal state, by applying a higher voltage charge. The cells or sectors can be organized in a group as a block so that multiple regions can be written or erased relatively simultaneously.

The controller 110 of non-volatile memory storage device 104 may have a memory management module 112, a file system module 114 comprising one or more file systems, and a file system scanning module 116.

Memory management module 112 may be programmed or designed with a flash page manager and may accept memory requests from the host interface 106 and, in response, may read, write, or erase a sector of memory, such as a cell, page, block, or entire memory chip. Memory management module 112 may achieve this result by translating or correlating a logical address to a physical memory address in memory storage 108.

The read, write, and/or erase events may be stored in the file system module 114. The file system module may include one or more file systems, which may be created on each device 104 by the host 102 or other programming device and may be associated with one or more memory storages 108. The file system may reside in a buffer memory on controller 110, or it may alternatively reside in memory storage 108 or on the host 102. Exemplary file systems include twelve-bit file allocation tables (FAT12), sixteen-bit file allocation tables (FAT16), thirty two-bit file allocation tables (FAT32), and New Technology File Systems (NTFS).

The file system scanning module 116 may be operable to scan the file system module to determine which sectors or blocks of memory 108 are no longer accessed by each file system. Such monitoring can be achieved by monitoring record files that indicate which files have been deleted in that file system and, therefore which sectors of memory are no longer valid.

The file system scanning module 116 may be enabled when an access request is not being generated by the host 102. For example, the scanning module 116 may be programmed to commence at a predetermined time after the memory management module 112 is idle with respect to the host 102. Alternatively or additionally, the file system scanning module 116 may be enabled independently of the status of the memory management module 112 relative to the host, such as at predetermined intervals. However, if the memory management module 112 receives a memory access request from host 102, the scanning operation being performed by the scanning module 116 may be temporarily suspended or aborted.

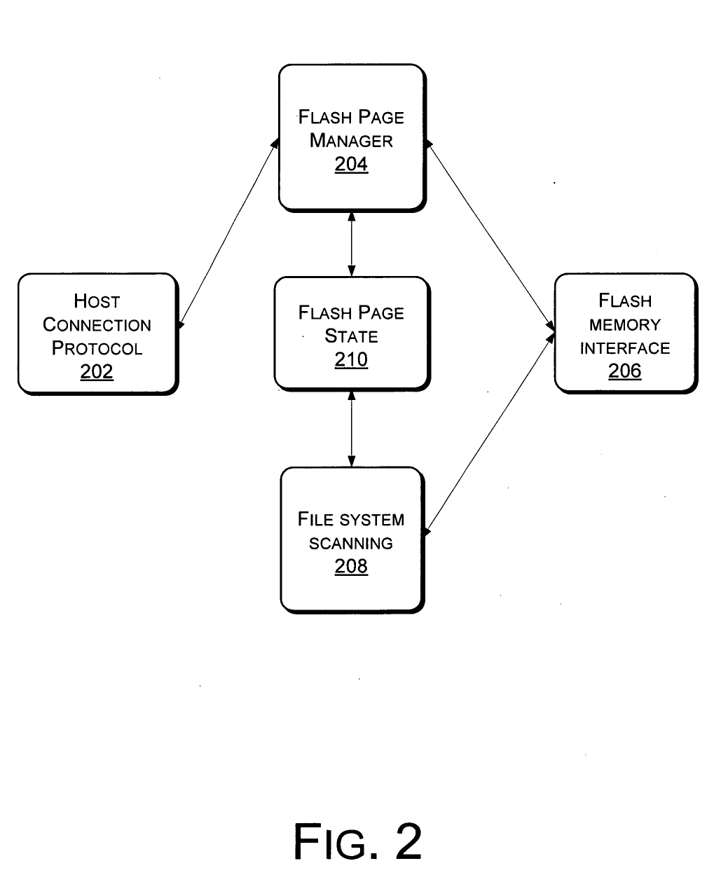

In response to the file system scan, an erase request may be generated by an erasing module and sent to memory management module 112 so that the invalid data in the memory 108 can be removed and the memory therefore conditioned or “pre-erased” for further write requests from the host 102. Thus, when a write command is given by host 102, the non-volatile memory storage device 104 can commence writing the data to the memory without having to first erase blocks of memory 108. The erasing module may be included in the file system scanning module 116, the memory management module 112 or other predetermined location. An implementation will now be described with reference to FIG. 2. In portions of the following discussion reference will be made to the environment shown in FIG. 1.

FIG. 2 shows the general architecture of software components that may be utilized to operate a non-volatile memory storage device 104, such as a flash memory device, and to scan a file system 114 located on the memory device 104. The software components may be installed on the memory device and integrated into a single piece of software or may separate software programs that may operate in concert. Thus, modules may be implemented via software program, a software component, firmware and/or hardware.

A host connection protocol module 202 may communicate with a flash page manager module 204 which, in turn, may interact with a flash memory interface module 206, such as a flash application program interface (API). The host connection protocol module may be any interface for accepting or delivering data read, write, and/or erase requests from the host 102 via a host communication connection, such as a (USB) port or a system bus. The host connection protocol module 202 may also be capable of other tasks such as resetting the device 104, reading the status of device 104, or enabling security protocols for access to the device 104.

The host connection protocol module 202 may accept a data read, write, or erase request from the host 102 and deliver the request to the flash page manager module 204. The flash page manager module 204 may be coupled to, and located on or within the same memory storage device 104 as, host connection protocol module 202. The flash page manager module 204 may be responsible for responding to the host data access requests and for communicating those requests to the flash memory interface module 206.

The flash page manager module 204 may communicate with flash memory interface module 206 to locate data in response to a read request sent to the host connection protocol module 202. The flash memory interface module 206 may communicate with the flash memory 108 and access the requested data located in the pages or blocks of memory. The flash page manager module 204 may also communicate with flash memory interface module 206 to determine whether an area of memory 108 is erased prior to being written with new data or to find an area to store data sent to the host connection protocol module 202 as part of a write request.

FIG. 2 also shows a file system scanning module 208, which may run in parallel with the flash page manager module 204 to determine the flash page state. The file system scanning module 208 scans and monitors the contents on the flash and the flash page state module 210, which may be a record maintained by the flash page manager module 204, to determine the status of sectors in blocks of the flash memory 108 that are no longer in use, for example those sectors that may be idle, inactive or invalid or which may contain data that is invalid. Data in the sectors may be invalid because the associated file in the file system has been erased or because the host is otherwise no longer accessing that sector. The file system scanning module 208 may then erase the blocks containing these sectors of memory. The blocks are thereby “pre-erased” because they have been erased in advance of a write request. Pre-erasing through the file system scanning module 208 reduces the “work” of the flash page manager module 204 during a write request because the flash page manager module 204 does not instruct the flash memory interface module 206 to erase the pre-erased blocks before writing new data to those blocks. Because fewer steps may be performed by the flash page manager module 204, the device can write new data with improved efficiency, thus improving device performance.

Although the file system scanning module 208 may scan data relating to requests previously made by the host protocol module 202, the file system scanning module 208 is generally independent of the host connection. Therefore, the file system scanning module 208 may be operated when the host protocol module 202 is idle with respect to the flash page manager 204 or, in other words, when the flash memory storage device 104 is idle with respect to the host 102.

The flash page state 210 or the flash page manager 204 may maintain a record of data sectors that have been erased and therefore which sectors are immediately available for writing.

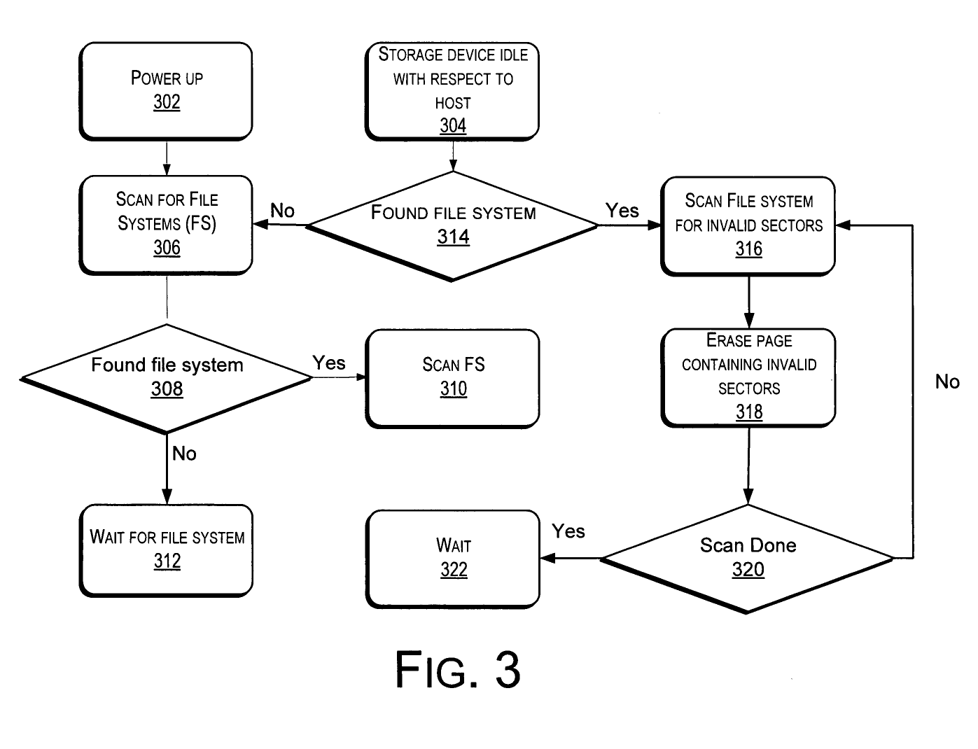

FIG. 3 illustrates an exemplary method to perform file system scanning and pre-erasing. Aspects of the procedure described herein may be implemented in hardware, software, or firmware, or a combination thereof. The procedure is shown as a set of blocks that specify operations performed by one or more devices and are not necessarily limited to the orders shown for performing the operations by the respective blocks. In portions of the following discussion reference will be made to the system shown in FIG. 1 and the implementation shown in FIG. 2.

The exemplary method for file system scanning and pre-erasing, shown in FIG. 3, may be implemented commencing at a variety of states, such as the power-up state (block 302) and/or the host connection idle state (block 304). The power-up state (block 302) may include the process of activating or providing power to the memory storage device 104. The host connection idle state (block 304) may occur after the device 104 is powered up, but at a point in time when the host does not request data access to the memory storage device 104.

In the power-up state (block 302), the system 100 attempts to locate each file system 114 installed on the device 104 (block 306). This process may be performed by the flash page manager module 204 or the file system scanning module 208. If a file system is found (“yes” from decision block 308), that file system in files system module 114 is scanned using the file system scanning module 208 in search of invalid sectors of data in flash memory 114 (block 310, jump to block 316). If a file system is not found (“no” from decision block 308), the system 100 waits for a file system to be written on the memory storage device 104 (block 312).

After the device 104 is powered up, it may be idle with respect to the host 102 (block 304). At this stage, the system 100 determines whether a file system has been found (decision block 314). If not (“no” from decision block 314), the system scans for file systems (block 306) and proceeds as described above. If a file system is located (“yes” from decision block 314), the file system is scanned for invalid sectors (block 316) using a file system scanning module 208. If a page or block is located containing invalid sectors, the page or block is erased (block 318). If additional blocks contain invalid sectors (“no” from decision block 320), the file system scanning module 208 scans and erases the additional blocks. If there are no additional invalid sectors, the system 100 waits (block 322) until additional scanning is to be performed (e.g. returns to block 302 or 304), which may be determined based on a predetermined time lapse, number of data access requests by the host and/or other predetermined condition.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. An apparatus comprising:
one or more nonvolatile memory sectors to hold data from a host; and
one or more modules which are to be activated when the apparatus is idle with respect to the host to:
access a file system to determine which of the one or more nonvolatile memory sectors are invalid with respect to the file system; and
erase data in the one or more nonvolatile memory sectors that are determined to be invalid.

2. An apparatus according to claim 1, further comprising a record file to maintain a record of the sectors that have had data erased.

3. An apparatus according to claim 1, wherein the one or more modules include a memory management module to accept memory access requests from the host and to access the requested data from the memory sectors in response the memory access request.

4. An apparatus according to claim 1, wherein the file system is located on the nonvolatile storage device.

5. An apparatus according to claim 1, wherein the nonvolatile memory storage is flash memory.

6. An apparatus according to claim 5, wherein the flash memory is “not or” (NOR) flash memory.

7. A system comprising:
a computing device having a liquid crystal display; and
a memory storage device connected to the computing device, the memory storage device comprising:
a nonvolatile memory storage medium to store data in data sectors;
a memory storage manager module to accept data requests from the host and, in response to the requests, access data in the nonvolatile memory storage medium;
a file system;
a file system scanning module to scan the file system to determine which data sectors contain data that is invalid with respect to the file system; and
an erasing module to erase the invalid data, the scanning module and erasing modules being activated when the host is not actively transferring data to or from the memory storage device.

8. A system according to claim 7, wherein the file system scanning module is to analyze a memory status record in the file system to determine what data is invalid with respect to the file system.

9. A system according to claim 7, further comprising a module to record information relating to the erased data.

10. The system of claim 7, wherein the nonvolatile memory storage is flash memory.

11. The system of claim 10, wherein the flash memory is “not ot” (NOR) flash memory.

12. A method comprising managing a file system in a nonvolatile memory storage device associated with a host by:
accessing a file system associated with the non-volatile memory storage device;
determining from the file system which sectors in the non-volatile memory storage device contain data that is invalid with respect to the file system; and
erasing the invalid data in the non-volatile memory storage device, wherein accessing, determining and erasing steps are performed when the nonvolatile memory storage device is idle with respect to the host.

13. A method according to claim 12, further comprising generating a record of the sectors that have had data erased after erasing the invalid data from the sectors.

14. A method according to claim 12, further comprising
scanning the nonvolatile memory storage device to determine if the file system has been created on the device, and
when the file system has not been created on the device, waiting for the file system to be created.

15. A method according to claim 14, wherein the scanning of the nonvolatile memory storage device to determine if a file system has been created on the device is performed when the device is initialized with respect to the host.

16. A method according to claim 14, wherein the scanning of the nonvolatile memory storage device to determine if a file system has been created on the device is performed when the device is idle with respect to the host.

17. A flash memory device comprising:
a host interface;
a flash memory chip to store blocks of data;
a flash application programming interface to interface with the flash memory;
a flash page manager to accept memory read and write access requests from the host interface and, in response to the requests, to access data stored in blocks of memory on the flash memory chip through the flash application programming interface;
a file system; and
a file system scanning module to scan the file system to locate a block of memory that contains data not associated with an active file in the file system and to erase the data on the block containing the data not associated with an active file in the file system before the flash page manager receives a write access request to write new data to the block containing the data not associated with an active file in the file system.

18. A flash memory device according to claim 17, wherein the file system scanning module analyzes a memory status record in the file system to locate the block of memory containing data is not associated with an active file in the file system.

19. A flash memory device according to claim 17, wherein the flash memory chip is “not or” (NOR) flash memory.

20. A flash memory device according to claim 17, wherein the file system scanning module is further to scan the flash memory device for an additional file system, the file system scanning module to scan the additional file system to locate a block of memory that contains data not associated with an active file in the additional file system and to erase the data on the block containing the data not associated with an active file in the additional file system before the flash page manager receives a write access request to write new data to the block containing the data not associated with an active file in the additional file system.
